(19) United States
(12) Patent Application Publication
(10) Pub. No.: US 2005/0202368 A1
(43) Pub. Date: Sep. 15, 2005

(54) Abutment for dental implant

(76) Inventor: Robert Ganley, Williamsville, NY (US)

Correspondence Address: Candice J. Clement;Nixon Peabody LLP, Clinton Square, P.O. Box 31051, Rochester, NY, 14603-1051, US

(21) Appl. No.: 10/799,513

(22) Filed: Mar. 12, 2004

(51) Int. Cl. A61C 8/00

(52) U.S. Cl. 433/173

(57) ABSTRACT

An implant abutment for attaching a dental prosthesis within a patient's mouth is disclosed. The abutment includes a core and a cuff surrounding the core, and the color of the cuff is matched to the color of the prosthesis. Dental restoration systems and methods for fabricating a dental implant restoration utilizing the abutment are also disclosed.

### FIELD OF THE INVENTION

The present invention relates generally to restorative dentistry. More specifically, the invention relates to an implant abutment for dental restorations.

### BACKGROUND OF THE INVENTION

Restorative dentistry has made significant advances in the use of dental implants to support dental restorations intended to permanently replace natural teeth. Dental implants provide an alternative to removable dentures, fixed partial dentures, and single-tooth restorations.

In a jawbone anchored dental restoration, an implant of known design is surgically implanted into a patient's jawbone, leaving a gingival surface exposed. A support post, commonly referred to as an abutment, is then firmly fixed to the exposed surface of the implant. A dental prosthesis is secured to the abutment by means of a screw extending through a bore in the prosthesis and into a threaded bore in the abutment (screw retained) or via conventional cementation techniques (cement retained).

As described, for example, in U.S. Pat. No. 4,988,298 to Lazzara et al., the entire content of which is incorporated herein by reference, and as shown in FIG. 1, a dental implant restoration system 10 generally includes a dental implant 14, a support post or abutment 16, and a prosthesis 12. The implant is typically made from a biocompatible material such as titanium or titanium alloy, and is embedded into the jawbone leaving a gingival surface 22 flush or nearly flush with the gingival surface A-A of the jawbone. This gingival end includes an internally-threaded recess 24 and a multi-sided male projection for abutting with the abutment 16. The abutment 16 is securely attached to the lower or gingival end of the prosthesis 12 and functions to provide a rigid interconnection between the implant 14 and the prosthesis 12.

A passageway extends through the abutment 16 and provides a recess at the transgingival portion for engaging the projection of the implant. A screw 26 abuts against a shoulder 28 of the abutment and engages the threaded recess 24 of the implant to force a precision formed abutment surface 29 into seated contact with the gingival surface of the implant. The prosthesis 12 is fabricated around the upper portion of the abutment and may be connected to the abutment via screw 26 or cement. The prosthesis is colored to match the surrounding dentition.

Typically, the abutment is made of metal, such as titanium, and the prosthesis is fabricated from ceramic, a ceramic-based material such as porcelain, or a polymeric resin material. An entirely metallic abutment however, can be visible through the prosthesis, resulting in a dark, central rod-like shadow, particularly when exposed to bright light, which makes the prosthesis somewhat unattractive since it is distinguishable from a natural tooth. Various methods for preventing or masking the appearance of the shadow are known in the art.

One attempt to solve the attractiveness problem involves making a support post entirely of tooth-colored ceramic material. This approach allows direct surface bonding by interaction of a porcelain coping and/or prosthesis to the support post, resulting in a secure and almost seamless bond between the prosthesis and support post. While presenting an attractive alternative to the use of a titanium support post, the proposed solution presents a number of problems.

Ceramic materials generally have a much greater hardness than titanium. When an all-ceramic support post is used, inevitable rocking of the support post due to, for example, chewing, causes a high stress interaction between the metal implant and the ceramic material of the post. Since a ceramic support post is of greater hardness than a titanium implant, it can and does cause damage to the implant. If sufficient damage is caused, eventual surgical intervention is required to remove and replace the titanium implant. In addition, ceramic material is typically not radiopaque, and when using conventional x-ray imaging to examine the juncture between the abutment and the titanium implant, the interface between the two elements is not readily viewable and adequate examination cannot be conducted. Moreover, fracture of the all-ceramic post is also a consideration.

Recognizing the benefits of a metallic support, U.S. Pat. No. 5,685,714 to Beaty et al. describes an abutment having two distinct sections. As seen in FIG. 2, abutment 12 includes an inner section, or core 36, made from titanium or a titanium alloy and an outer section, or cuff 34, made from ceramic, typically aluminum oxide. The metallic core 36 provides the necessary strength to the abutment and provides a framework for connecting prosthesis 38 to implant 40. The ceramic cuff 34 preferably surrounds the entire exterior surface of the core 36, and shields the shadow of the metallic core 36 through the prosthesis 38. PureForm™ (Centerpulse Dental Inc., Carlsbad, Calif.), for example, is a tooth-shaped abutment composed of a titanium core and a ceramic cuff made of an alumina/zirconia blend. Screw-retained alumina or zirconia/alumina based abutments are available under the trademarks Bio-Cera™ (Bio-Lok International, Inc., Deerfield Beach, Fla.), CerAdapt™ (Nobel Biocare™ AB, Göteborg, SE) and ZiReal™ Post (Implant Innovations, Inc., Wilmington, Del.).

U.S. Pat. No. 6,497,573 to Wagner et al. describes a three part dental abutment that includes a shield between a metallic core and a polymeric cuff. The shield is preferably formed of an opaque material, such as a mixture of several mono and dimethacrylates, and may include various pigments to provide a variety of colors to best shield or mask any grayish or metallic color of the core.

Each of the aforementioned devices however, have certain drawbacks. The three part system is inherently more costly, both in time and materials. The two part systems, while effectively masking the shadow of the metallic core, result in the requirement for additional time and expertise in the fabrication of the prosthesis. When utilizing an entirely metallic abutment, the technician simply acknowledged the resulting appearance of the shadow and fabricated a prosthesis that matched the surrounding dentition. With the addition of a cuff component, however, the color of the cuff and the color of the prosthesis combine to create the color of the final restoration, and the technician must therefore take the color of the abutment into consideration when fabricating the prosthesis.

This is particularly important when the prosthesis is fabricated of ceramic. Since most ceramic restorations have inherent translucency, it is incumbent that the abutment be shaded so that it complements the desired shade of the restoration. This process is similar to determining the shade of a natural tooth prior to the fabrication of an all ceramic crown. In that case, it is recognized that the underlying natural tooth or “stump” will influence the shade of the final restoration.

Conventional abutments, such as PureForm™ Ceramic Coping (Centerpulse Dental Inc., Carlsbad, Calif.), Bio-Cera™ (Bio-Lock International, Inc., Deerfield Beach, Fla.), CerAdapt™ (Nobel Biocare™ AB, Göteborg, SE) and ZiReal™ (Implant Innovations, Inc., Wilmington, Del.), are typically available in one standard color chosen by the manufacturer, regardless of the material they are made from. Thus, an “exact match” between the abutment and prosthesis is not achieved. CerAdapt™ abutments for example, are available in Vita-Shade™ A-3 (Vita Shade™ Guide, Vident, Brea, Calif.).

### SUMMARY OF THE INVENTION

In one embodiment, the present invention provides an aesthetic implant abutment for attaching a restorative dental prosthesis within a patient's mouth. In accordance with the invention, the implant abutment includes a core and a cuff surrounding the core, wherein the cuff is colored to match the color of the prosthesis.

In various embodiments, the core is fabricated from metal, such as titanium or a titanium alloy, and the cuff and prosthesis are fabricated from a ceramic or polymeric material. In a preferred embodiment, both the cuff and prosthesis are formed of ceramic.

The invention further provides a dental implant restoration system that includes an implant, a dental abutment having a core and a cuff surrounding the core fixed to the implant, and a dental prosthesis fixed to the abutment, wherein the abutment cuff is colored to match the color of the prosthesis.

The invention also provides a method of fabricating a dental implant restoration that includes, fixing an implant within a patient's mouth;
fixing a dental abutment having a core and a cuff surrounding the core, to the implant; and
fixing a dental prosthesis to the abutment, wherein the abutment cuff is colored to match the color of the prosthesis.

### BRIEF DESCRIPTION OF DRAWINGS

FIG. 1 is a partial cross-sectional view of a prior art dental abutment fixed within a dental implant restoration system.

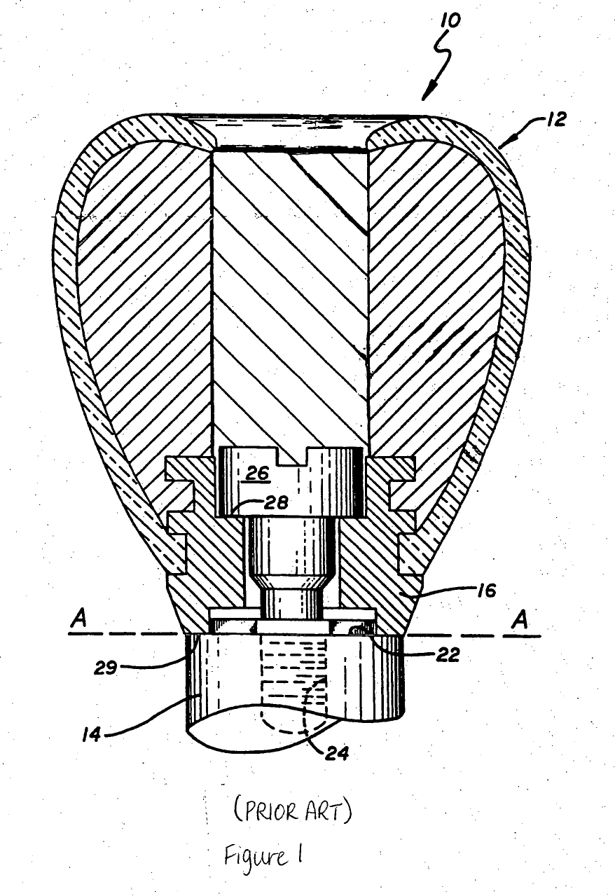

FIG. 2 is a partial cross-sectional view of a prior art dental abutment fixed within a dental implant restoration system.

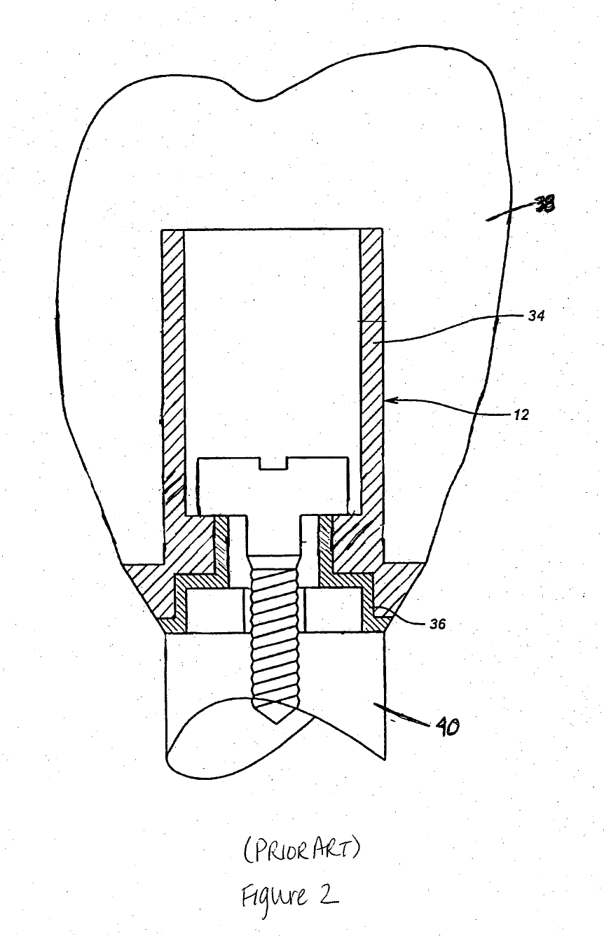

FIG. 3 is a partial cross-sectional view of a dental restorative system according to one embodiment of the present invention.

### DETAILED DESCRIPTION OF THE INVENTION

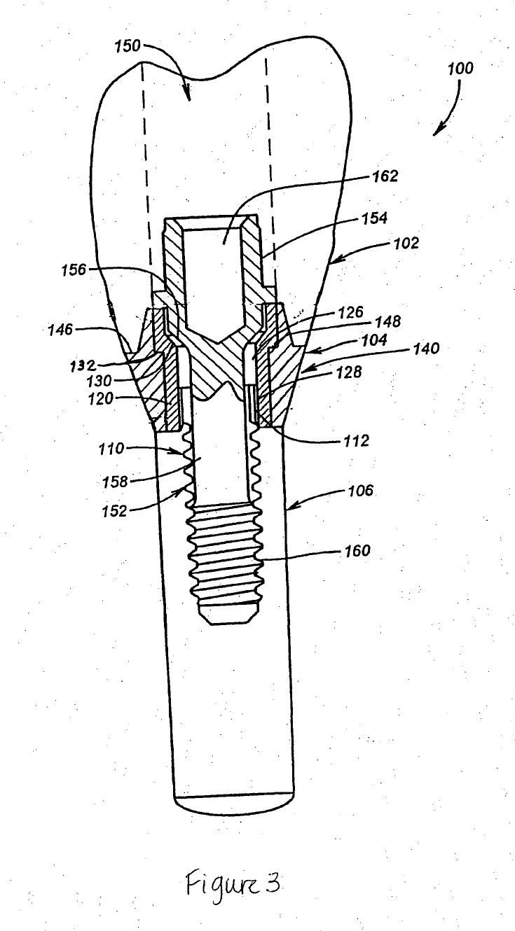

FIG. 3 shows a dental restorative system 100 that includes a prosthesis 102, an abutment 104, and an implant 106. The abutment and prosthesis are attached together and connected to the implant as illustrated.

Implant 106 has a coronal or gingival end with a threaded bore 110 and a male engaging feature 112 extending upwardly. The coronal end extends downwardly along a cylindrical body to a distal end. The male engaging feature 112 connects to the abutment and may be a plurality of upwardly extending tines, a polygon, or other type feature known to those skilled in the art. Alternatively, the implant may have female engaging features that correspond with male projections on the abutment core. The implant may be any one of various implants known in the art, such as those manufactured by Sulzer Calcitek Inc. (Carlsbad, Calif.).

Abutment 104 has two different and distinct sections preferably formed from two different materials. Core section 120 has a cylindrical configuration and extends from a top portion to a bottom portion. A passageway 126 extends centrally through the core. The bottom portion abuts against the coronal end of implant 106. Abutment 104 may be provided with a female engaging feature 128 that engages with the male engaging feature 112 to provide an anti-rotational connection between the abutment and implant. The engaging features would have matching configurations to provide the noted anti-rotational connection. Numerous configurations of engaging features known to those skilled in the art (such as Spline® tines, octagons, and other polygons) may be used.

Core 120 typically includes a shoulder 130 located along the interior of the passageway 126 at the top portion. A corresponding ledge 132 is formed along the exterior surface adjacent shoulder 130. Preferably, the core is made from a biocompatible metal, such as titanium or its alloys. The metallic core provides strength to the abutment and a framework for connecting the prosthesis to the implant.

An abutment cuff section 140 connects to the exterior surface of the core 120 and, preferably, surrounds the entire exterior surface. The cuff has a somewhat cylindrical configuration and extends from an upper portion to a lower portion. The cuff can be shaped around the core to have various configurations, such as a cylindrical or elliptical configuration or an anatomical shape that resembles the cross section of a natural tooth.

As shown in FIG. 3, the cuff 140 tapers outwardly and upwardly away from the coronal end of the implant 106 and forms a frusto-conical shape. This tapering continues to a ledge 146 and then transitions to taper inwardly at the upper portion of the cuff 140. A shoulder 148 is located along the inner surface. This shoulder 148 fits with the mating ledge 132 on the exterior of the core.

The prosthesis 102 is shaped as a natural tooth and includes a passageway 150 that aligns with the passageway 126 of the abutment. A screw 152 passes into these passageways until a head 154 of the screw abuts against the top portion of the core. As shown, the lower portion of the head includes a taper 156 that abuts against the shoulder 130 along the interior of the core. The screw includes a shank 158 extending from the head. This shank has a threaded portion 160 that fits into the coronal end of the implant to engage corresponding threads in threaded bore 110. The screw holds the abutment and attached prosthesis to the implant. The head 154 also includes a recess 162. The recess may be provided to engage a tool (not shown) for tightening and loosening the screw or provided to threadably engage another screw (not shown) to secure the prosthesis.

In accordance with one embodiment of the invention, the color of the abutment cuff 140 matches the color of the prosthesis 102. While the cuff 140 and the prosthesis 102 are preferably made from a ceramic material, such as the zirconia/alumina composite described in U.S. Pat. No. 6,380,113 to Kim et al., various polymers and polymer combinations such as acrylic polymers; fiber, glass, silica, and alumina reinforced polymers; thermosetting and photosensitive polymers; vinylesters; and epoxy type materials, may also be used. Suitable polymers include Sculpture® or FibreKor™ of Jeneric/Pentron, Inc. (Wallingford, Conn.) and Targis™ or Vectris™ of Ivoclar Vivadent, Inc. (Schaan, LI).

In the context of the present invention, “matching” the color of the abutment cuff to the color of the prosthesis means choosing a color for the abutment cuff that is most similar to the color of the prosthesis. Generally, a restoration is fabricated in more than one color shade, typically with a darker shade at the gingival surface and a brighter shade at the top. However, the abutment color is selected to match the overall color of the prosthesis, especially at the interface of the abutment 140 and the restoration 104.

Several methods are known in the art for determining the color of a dental restoration. Most commonly used is a dental shade guide, which generally has a base supporting a plurality of tabs or other indicia, each of which corresponds to a different color. The colors of the tabs/indicia represent a range of standard tooth colors. U.S. Pat. No. 6,139,318 to Foser, for example, the entire content of which is incorporated herein by reference, describes a particularly useful color key for selecting a proper color for a dental restoration. The color key includes a number of detachable, tooth sample elements that are formed of the same materials and colored in the same manner, as the dental restoration. In addition, the tooth sample elements include a first surface having a texture and curvature that matches a natural tooth, and a second surface that is smooth and flat. The first surface provides the possibility to test the impression the identically produced restoration will have in the same location, while the second surface provides an improved evaluation of color only, as it can be positioned more easily within the patient's mouth for comparison with surrounding dentition.

Other, commercially available dental shade guides include, for example, Chromoscop® (Ivoclar Vivadent, Inc., Schaan, LI); Vitapan Classical™ (Vita-Lumin™ Vacuum Shade Guide) and Vitapan 3-D Master™ (Vident, Brea, Calif.); and Bioform™ and TruMatch™ (Dentsply International, Inc., Milford, Del.).

Once the color of the prosthesis has been determined, an abutment having a cuff that most similarly matches that color is used in the implant restoration. Depending upon the dental shade guide system being used, a series of colored abutments, specific for that system, would be available to chose from.

The principles of the present invention thus provide several advantages over conventional dental implant restoration systems. The invention simplifies the restoration process, in that the fabrication of the prosthesis no longer has to take the color of the abutment into consideration. The abutment includes a cuff matching the color chosen for the prosthesis. Therefore, the interface between the abutment and the restoration is aesthetically enhanced and visually less detectable. In contrast, in accordance with the prior art, the color of the restoration was determined by the combination of the colors of the abutment and the prosthesis. Typically, the technician creating the restoration would obtain a standard abutment and then determine a color for the prosthesis that, when combined with the color of the abutment, would result in the desired color for the final restoration.

By utilizing an abutment having the same color as the prosthesis, the final restoration has a greater depth, providing a much more natural appearance. Just as the “stump” of a damaged tooth provides a natural-colored framework for the reconstruction of the tooth, the abutment of the present invention provides a natural-colored framework for the fabrication of a prosthesis.

In some instances, the restoration may include a layer of dental cement between the abutment and the prosthesis. Prior to the present invention, the practitioner would choose a cement having a color that would properly combine with the colors of the abutment and the prosthesis, to obtain the desired color for the final restoration. With the present invention, however, because the abutment matches the color of the prosthesis, no additional determinations are required, and a clear cement may be used.

In a typical jawbone anchored dental restoration, after the implant system has been fixed within the patient's mouth, the gum is restored around the system, such that it extends above the lower surface of the prosthesis. With normal aging however, it is not uncommon that the gum line will recede, exposing the lower surface of the prosthesis, as well as a portion of the abutment. With prior art abutments, this could cause an unsightly, unnatural appearance. In accordance with the present invention, however, as the color of the prosthesis and the abutment cuff are matched, the appearance of the abutment is not noticeable even if exposed, and the implant restoration blends naturally with the surrounding dentition.

### EXAMPLE

Adequate alveolar bone must first be present at an edentulous site in order to properly treat a patient with a dental implant. After the secure placement of the dental implant in the patient's jawbone, an appropriate abutment type is selected that will provide support for the final restoration. Where the final restoration being considered is an all-ceramic restoration, selection of an implant abutment according to the present invention, that is color-shaded similar to natural teeth is suggested, as opposed to a metallic abutment which may shadow through the ceramic prosthesis and affect the color of the all-ceramic restoration. An impression and shade is taken using one of the known shade guide systems and sent to the laboratory for fabrication of the final restoration. The color of the abutment is matched to the chosen color for the restoration. The final restoration is then fit within the patient's mouth and permanently mounted.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. An implant abutment for attaching a dental prosthesis within a patient's mouth, comprising:
a core; and
a cuff surrounding the core,
wherein the cuff is colored to match the color of the dental prosthesis.

2. The product of claim 1, wherein the core is formed of a metallic material.

3. The product of claim 2, wherein the metallic material is titanium or a titanium alloy.

4. The product of claim 1, wherein the cuff is formed of a ceramic or a polymeric material.

5. The product of claim 1, wherein the prosthesis is formed of a ceramic or a polymeric material.

6. The product of claim 2, wherein the cuff and prosthesis are formed of a ceramic material.

7. A dental implant restoration system comprising:
an implant fixed within a patient's jaw;
an abutment having a core and a cuff surrounding the core, fixed to the implant; and
a dental prosthesis fixed to the abutment,
wherein the abutment cuff is colored to match the color of the dental prosthesis.

8. The system of claim 7, wherein the abutment core is formed of a metallic material.

9. The system of claim 7, wherein the abutment cuff is formed of a ceramic or a polymeric material.

10. The system of claim 7, wherein the dental prosthesis is formed of a ceramic or a polymeric material.

11. The system of claim 8, wherein the abutment cuff and the dental prosthesis are formed of a ceramic material.

12. A method for fabricating a dental implant restoration comprising:
fixing an implant within the jawbone of a patient;
fixing an abutment having a core and a cuff surrounding the core, to the implant; and
fixing a dental prosthesis to the abutment,
wherein the abutment cuff is colored to match the color of the dental prosthesis.

13. The method according to claim 12, wherein the abutment core is formed of a metallic material.

14. The method according to claim 12, wherein the abutment cuff is formed of a ceramic or a polymeric material.

15. The method according to claim 12, wherein the dental prosthesis is formed of a ceramic or a polymeric material.

16. The method according to claim 13, wherein the abutment cuff and the dental prosthesis are formed of a ceramic material.
